(19) United States
(12) Patent Application Publication
(10) Pub. No.: US 2020/0407257 A1
(43) Pub. Date: Dec. 31, 2020

(54) BURNER FOR A MELTING CHAMBER

(71) Applicant: Owens-Brockway Glass Container Inc., Perrysburg, OH (US)

(72) Inventors: SHANE T RASHLEY, Bowling Green, OH (US); LIMING SHI, Perrysburg, OH (US); ZHONGMING WANG, Ypsilanti, MI (US)

(21) Appl. No.: 16/456,222

(22) Filed: Jun. 28, 2019

(51) Int. Cl. C03B 5/235

(52) U.S. Cl. CPC C03B 5/2356

(57) ABSTRACT

Devices and methods of using a burner and/or a protective cap for a melting chamber are disclosed. In particular, the melting chamber includes a chamber wall and a burner. The chamber wall has a longitudinal axis and forms a passage having a passage axis transverse to the longitudinal axis. The chamber wall also has an inner wall surface with an inner wall edge extending about the passage. The burner is positioned in the passage and has a tubular body with a burner end spaced away from the inner wall edge so that a space exists between the burner end and the inner wall edge. The tubular body also has an outer burner diameter, an inner burner diameter, and a central conduit within the inner burner diameter.

This patent application discloses devices and methods of glass manufacturing, and more particularly, devices to extend the life of a glass melting chamber.

### BACKGROUND

Glass manufacturing often occurs at high temperatures that require the equipment used in the glass manufacturing process to withstand harsh conditions. In particular, submerged combustion melting (“SCM”) is a specific type of glass manufacturing, in which an air-fuel or oxygen-fuel mixture is injected directly into a pool of molten glass. As combustion gases bubble through the molten glass, they create a high-heat transfer rate and turbulent mixing of the molten glass until it achieves a uniform composition. A typical submerged combustion melting chamber has a floor and a vertical burner passage extending through the floor. A burner positioned within the burner passage is submerged in the molten glass.

Not only does the burner, particularly at its top surface, experience high temperatures, but it also undergoes extreme temperature oscillations. These harsh conditions can lead to cracks and/or erosion forming in the burner, leakage, and the need for burner replacement and downtime of the melting chamber.

### BRIEF SUMMARY OF THE DISCLOSURE

The present disclosure embodies a number of aspects that can be implemented separately from or in combination with each other.

In accordance with one aspect of the disclosure, there is a melting chamber including a chamber wall, a burner, and a cap. The chamber wall has a longitudinal axis and forms a passage having a passage axis transverse to the longitudinal axis. The chamber wall includes an inner wall surface with an inner wall edge extending about the passage. The burner is positioned in the passage and has a tubular body with a burner end spaced away from the inner wall edge so that a space exists between the burner end and the inner wall edge. The tubular body also has an outer burner diameter, an inner burner diameter, and a central conduit within the inner burner diameter. The cap is at least partially positioned in the space between the burner end and the inner wall edge. The outer cap surface also has an inner cap edge with a cap diameter that can be larger than, equal to, or less than the inner burner diameter of the hunter. The inner cap edge extends about the central conduit so that it forms a bore coaxially aligned with the passage.

In accordance with another aspect of the disclosure, there is a melting chamber including a chamber wall and a burner. Similar to the chamber wall discussed above, it has a longitudinal axis and forms a passage having a passage axis transverse to the longitudinal axis. The chamber wall includes an inner wall surface with an inner wall edge extending about the passage. Further, the chamber wall has a non-fluid-cooled portion and a fluid-cooled portion so that the non-fluid-cooled and fluid-cooled portions are disposed in two layers and contact each other at a boundary. The burner is positioned in the passage and has a tubular body with a burner end spaced away from the inner wall edge so that a space exists between the burner end and the inner wall edge. The tubular body has no coolant passage for a cooling fluid and has an outer burner diameter, an inner burner diameter, and a central conduit, within the inner burner diameter. The outer and inner burner diameters of the tubular body extend at least to the boundary of the non-fluid-cooled and fluid-cooled portions, and the central conduit may have a distal end that can be proximal the boundary of the non-fluid-cooled and fluid-cooled portions along the passage axis.

In accordance with yet another aspect of the disclosure, there is a melting chamber including a chamber wall and a burner. Similar to the chamber wall discussed above, it has a longitudinal axis and forms a passage having a passage axis transverse to the longitudinal axis. The chamber wall includes an inner wall surface with an inner wall edge extending about tire passage. The chamber wall has a non-fluid-cooled portion and a fluid-cooled portion so that the non-fluid-cooled and fluid-cooled portions are disposed in two layers and contact each other at a boundary. The burner is positioned in the passage and has a tubular body with a burner end spaced away from the inner wall edge so that a space exists between the burner end and the inner wall edge. The tubular body has no coolant passage for a cooling fluid and has an outer burner diameter, an inner burner diameter, and a central conduit within the inner burner diameter. The outer and inner burner diameters of the tubular body extend along the passage axis but do not extend along either of the non-fluid-cooled and fluid-cooled portions. The central conduit has a distal end that is distal to the outer and inner burner diameters.

### BRIEF DESCRIPTION OF THE DRAWINGS

The disclosure, together with additional objects, features, advantages and aspects thereof, will be best understood from the following description, the appended claims and the accompanying drawings, in which:

FIG. 1 is a fragmentary, cross-sectional view of a melting chamber, cap, and burner in accordance with an illustrative aspect of the present disclosure;

FIGS. 2A-E depict various geometries of the cap of FIG. 1 in accordance with various aspects of the present disclosure;

FIG. 3 is a fragmentary, cross-sectional view of a chamber wall, cap, and burner in accordance with an illustrative aspect of the present disclosure;

FIG. 4 is another fragmentary, cross-sectional view of a chamber wall, cap, and burner in accordance with an illustrative aspect of the present disclosure;

FIG. 5 is another fragmentary, cross-sectional view of a chamber wall, cap, and burner in accordance with an illustrative aspect of the present disclosure;

FIG. 6 is another fragmentary, cross-sectional view of a chamber wall, cap, and burner in accordance with an illustrative aspect of the present disclosure;

FIG. 7 is another fragmentary, cross-sectional view of a chamber wall, cap, and burner in accordance with an illustrative aspect of the present disclosure;

FIG. 8 is a graph depicting time versus temperature at a distal end of the burner of FIG. 1 in accordance with an illustrative aspect of the present disclosure;

FIG. 9 is a graph depicting time versus temperature at a horizontal surface that includes the distal end of the burner of FIG. 1 in accordance with an illustrative aspect of the present disclosure; and

FIG. 10 is a graph depicting time versus temperature at an inner edge of the melting chamber of FIG. 1 in accordance with an illustrative aspect of the present disclosure.

### DETAILED DESCRIPTION

A general object of the present disclosure, in accordance with one aspect thereof, is to provide a burner of a melting chamber that has a longer lifespan and/or requires less maintenance than prior burners.

As briefly described in the background, harsh conditions within a melting chamber, particularly in SCM, can lead to burner cracking, erosion, and/or failure. Temperatures in the melting chamber can be several thousands of degrees Celsius (C) or Kelvin (K). A typical burner creates combustion gases by mixing a supply of oxidant with a supply of fuel. The combustion gases create bubbles in a molten material within the melting chamber that originate in the burner and detach in a cyclical manner. As relatively colder oxidant and fuel recirculates near a distal end and/or a top of the burner, the oxidant and/or the fuel lower the temperature near a distal end of the burner. As hot combustion gases recirculate near the distal end of the burner, they increase the temperature near the distal end of the burner. This recirculation of the oxidant, fuel, and combustion gases creates extreme temperature oscillations that happen continuously and in a very short amount of time. Each temperature oscillation can occur in one or less seconds, for example, in the range of 0.001 to 1.0 seconds, including all ranges, subranges, and values therebetween, in addition to the high temperatures experienced by the burner.

Over time, the distal end of the burner can fail due to these harsh conditions. The burners are often constructed from various materials, including metal, for example, stainless steel. Cracks form in the metal at the distal end. Once a crack forms, liquid, water, coolant, molten material, or the like can leak out of the burner. This leakage requires a burner to be repaired or replaced, which can be challenging if the melting chamber is currently housing the molten material. Such a repair or replacement may require draining all molten material and/or the melting chamber to be out of operation for a long period of time.

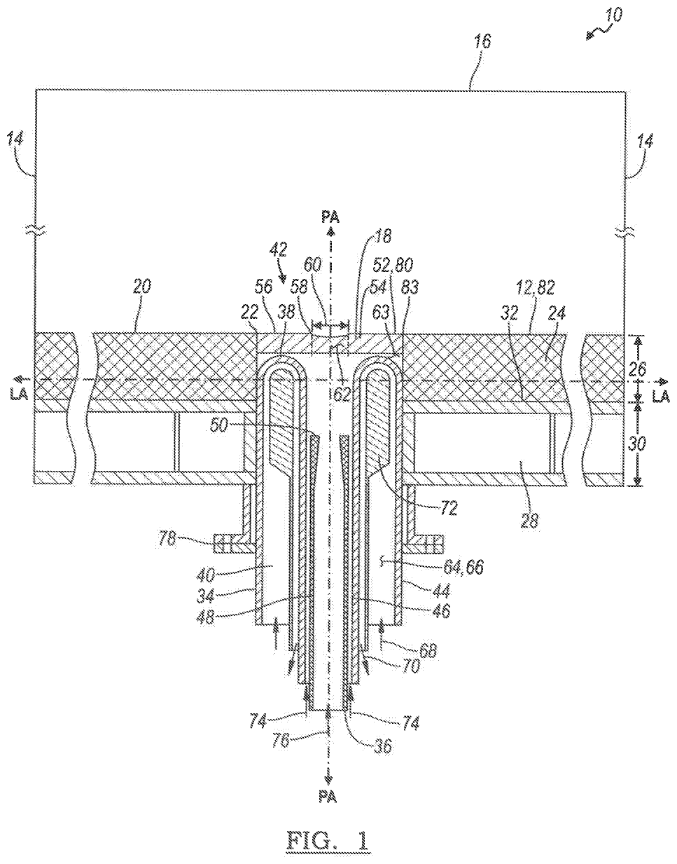

In order to protect and extend the useful lifetime of the burner in the melting chamber, FIG. 1 illustrates a melting chamber 10 that has a protective cap. The melting chamber 10 in FIG. 1 includes a chamber wall 12 with a longitudinal axis LA. In this aspect, the chamber wall 12 can be a floor of the melting chamber 10: however, it will be appreciated that the chamber wall 12 could also be a side wall 14 or roof 16 of the melting chamber 10. The chamber wall 12 forms a passage 18 having a passage axis PA being transverse to the longitudinal axis LA. The chamber wall 12 also has an inner wall surface 20 with sin inner wall edge 22 extending about or around the passage 18.

Below the inner wall surface 20, the chamber wall 12 also includes a non-fluid-cooled portion 24 having a first height 26 and a fluid-cooled portion 28 having a second height 30. The non-fluid-cooled and fluid-cooled portions 24, 28 are depicted as being disposed in two layers so that the non-fluid-cooled portion 24 is directly contacting the inner wall surface 20 and the fluid-cooled portion 28 is separated from the inner wall surface 20 by the non-fluid-cooled portion 24. The non-fluid-cooled and fluid-cooled portions 24, 28 directly contact each other at a boundary 32.

The non-fluid-cooled portion 24 can include a refractory material that can withstand the harsh environment in the melting chamber 10 because it is closer to and/or in direct contact with the molten material. Contrastingly, the fluid-cooled portion 28 can include metal and have voids for passing a cooling fluid because it is farther away from and/or not in direct contact with the molten material. The cooling fluid can protect other components in tire melting chamber 10, such as portions of the burners. In some aspects, the fluid-cooled portion 28 is positioned adjacent or closer to the atmosphere outside of the melting chamber 10 than the non-fluid-cooled portion 24.

A burner 34 is depicted in the passage 18. The burner 34 can have a tubular body 40 that extends between a proximal end 36 and a distal end 38. As used in this disclosure, “proximal” means farther away from the molten material and “distal” means closer to the molten material, relative to each oilier. The distal end 38 of the burner 34 is spaced away from the inner wall edge 22 so that a space 42 exists between the distal end 38 of the burner 34 and the inner wall edge 22. The space 42 can have various volumes. In one aspect, the space 42 at least 0.67″ deep, between the inner wall edge 22, and/or the inner wall surface 20, and the distal end 38 of the burner 34. If nothing fills the space 42, the molten material from the melting chamber 10 may at least partially fill the space 42. Additionally, the combustion gases can also at least partially occupy the space 42.

The tubular body 40 of the burner 34 also has an outer burner diameter 44, an inner burner diameter 46, and a central conduit 48 within the inner burner diameter 46. The outer and inner burner diameters 44, 46 can be outer and inner parts, respectively, of a tubular member of the burner 34. However, they could each also be separate tubular members from each other. The central conduit 48 can have a diameter that is smaller than the inner burner diameter 46, in order to fit within it, and it also has a distal end 50. The outer and inner burner diameters 44, 46 and the central conduit 48 can pass various oxidants and fuels through the burner 34 to create the combustion gases, which will be discussed in further detail below.

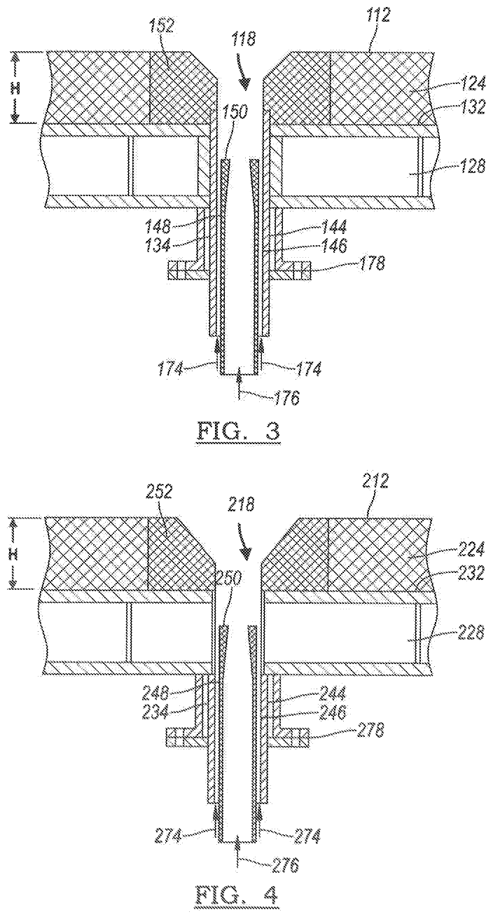

In particular in FIG. 1, the outer and inner burner diameters 44, 46 of the burner 34 extend distal to the boundary 32 of the non-fluid-cooled and fluid-cooled portions 24, 28, along the passage axis PA, so that the outer and inner burner diameters 44, 46 extend along both of the non-fluid-cooled and fluid-cooled portions 24, 28. Contrastingly, the distal end 50 of the central conduit 48 is proximal to the boundary 32 of the non-fluid-cooled and fluid-cooled portions 24. 28, along the passage axis PA, so that the central conduit 48 extends along only the fluid-cooled portion 28 and not the non-fluid-cooled portion 24. Further possible orientations of the distal ends of the outer and inner burner diameters 44, 46 and the central conduit 48 are also possible, and some further aspects will be discussed with FIGS. 3-7. For example, the distal end 50 of the central conduit 48 could also extend distal to the boundary 32 of the non-fluid-cooled and fluid-cooled portions 24, 28 and still be proximal to the distal end 38 of the burner 34 and/or the distal end of the outer and inner burner diameters 44, 46.

In order to protect the burner 34, a cap 52 can be disposed in the space 42 distal the burner 34. FIG. 1 depicts the cap 52 positioned in the space 42 between the distal end 38 of the burner 34 and the inner wall edge 22. The cap 52 has a body 54 with an outer cap surface 56 that may be aligned with the inner wall surface 20. It will be appreciated that the outer cap surface 56 may also be positioned higher or lower than the inner wall surface 20. The outer cap surface 56 also has an inner cap edge 58 that can be generally circular and can have a cap diameter 60 that is larger than, equal to, or less than the inner burner diameter 46. The inner cap edge 58 extends about or around the central conduit 48 so that the cap 52 forms a bore 62 therethrough and that is coaxially aligned with the passage 18. FIG. 1 depicts that, in some embodiments, the inner cap edge 58 may be substantially aligned with the inner burner diameter 46. For purposes of this disclosure, “substantially” or “about” mean that a given quantity is no more than 10%, preferably no more than 5%, more preferably no more than 1%, of a comparison or stated value. For example, “substantially aligned” means that the inner cap edge 58 and the inner burner diameter 46 are positioned along the passage axis in a position that is no more than 10%, preferably no more than 5%, more preferably no more than 1% out of alignment with each other. However, in some embodiments, the inner cap edge 58 may not be substantially aligned with the inner burner diameter 46.

As seen in FIG. 1, the distal end 38 of the burner 34 is spaced away from the cap 52 along the passage axis PA such that a void 63 exists underneath the cap 52 and/or between the cap 52 and the burner 34. Cool oxidant and/or fuel may fill the void 63, which can function as an insulation so that the distal end 38 is exposed to a lower temperature. In some embodiments, the distal end 38 of the burner 34 may be positioned proximate to the cap 52 so that there is no void. FIG. 1 also depicts that the cap 52 is only disposed between the distal end 38 of the burner 34 and the inner wall edge 22 along the passage axis PA. However, it is certainly possible that the cap 52 could extend distal to the inner wall edge 22, and further into the melting chamber 10, and/or that it could extend proximal the distal end 38 of the burner 34.

The burner 34 in FIG. 1 includes a plurality of coolant passages 64 for passing a cooling fluid 66 within the burner 34. In particular, the outer and inner burner diameters 44, 46 form a hollow tube that can pass a cooling fluid 66 in through a coolant inlet 68 and out through a coolant outlet 70. The hollow tube includes an insert 72 for forming the coolant passages 64. While FIG. 1 depicts the coolant passages 64, other aspects of the burner 34 will be described below in which there are no coolant passages 64 for the cooling fluid 66 in the burner 34.

Also seen in FIG. 1, at the proximal end 36 of the burner 34, are an oxidant inlet 74 and a fuel inlet 76 for passing oxidant and fuel to create the combustion gases. As depicted, the oxidant and fuel remain separate, and potentially of a lower temperature, until they mix at the distal end 50 of the central conduit 48. At this point, they may increase in temperature as they combust and raise the temperature of the distal end 38 of the burner 34. The burner 34 can be connected to the chamber wall 12 at a connection 78 between respective flanges of the burner 34 and chamber wall 12.

In addition to the position of the cap 52, it can include a first material 80 that is the same or different with a second material 82 that is included in the chamber wall 12. By using the first material 80 with the higher durability, the cap 52 can further protect the area at the distal end 38 of the burner 34 from the harsh conditions of the melting chamber 10. However, the first material 80 can be costly and/or otherwise impractical fry other areas of the melting chamber 10, including the chamber wall 12. In one example, the first material 80 can be aluminum-zirconia-silica, silica, chrome, alumina, zirconia-mullite, mullite, platinum, ruthenium, rhodium, palladium, silver, osmium, iridium, gold, an alloy thereof, or the like. In some aspects, the cap 52 can be secured to the chamber wall 12 with a castable refractory material 83 between the chamber wall 12 and the cap 52 to fix and/or seal them together.

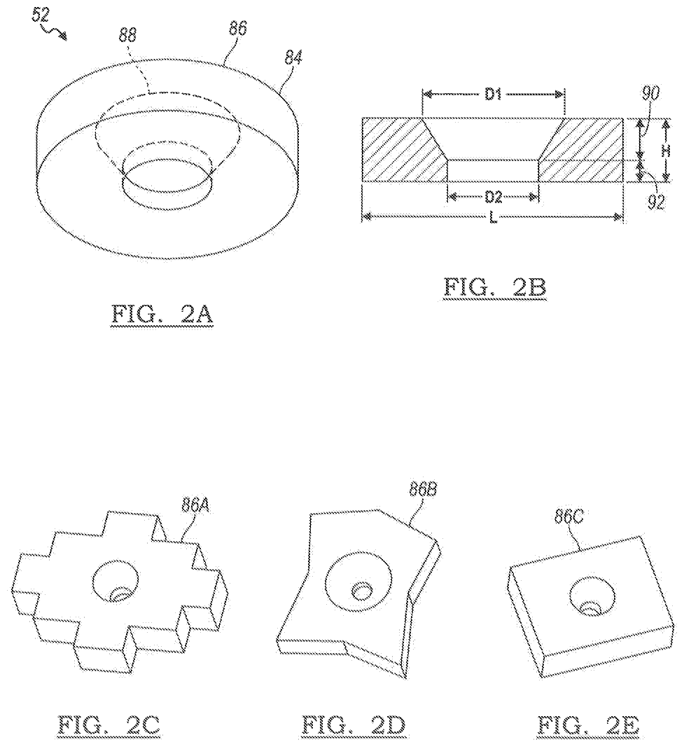

FIGS. 2A-E depicts further details of the cap 52. The cap 52 has a cap exterior 84 that can comprise a variety of cross-sectional shapes 86. FIG. 2A depicts the cap 52 as a hollow cylinder so that the cap exterior 84 has a circular or ring-shaped cross-sectional shape 86. FIGS. 2C-E depict that the cross-sectional shape could be a polygon 86A, star 86B, or rectangle 86C, respectively. Other cross-sectional shapes are possible, including a square, triangle, or the like. Whatever the chosen shape, it can correspond to the cross-sectional shape of the passage 18.

The cap 52 also has a cap interior 88 with a first cap diameter D1 and a second cap diameter D2. The first cap diameter D1 is disposed at the inner cap edge 58. The second cap diameter D2 is disposed along the passage axis PA so that the second cap diameter D2 is less than or equal to the first cap diameter D1. If the first and second cap diameters D1, D2 are equal, then the diameter of the cap interior 88 does not vary along the passage axis PA, and the cap 52 generally forms a hollow cylinder. However, if the first cap diameter D1 tapers so that the second cap diameter D2 is less than the first cap diameter D1, then the cap 52 forms a tapered cylinder (depicted in FIGS. 2A-B). As depicted in FIG. 2B, the taper of the first cap diameter DJ can have a first height 90. The second cap diameter D2 can extend along a second height 92. The cap interior 88 has an overall height H. The cap 52 also has a length L.

The second cap diameter D2 and the length L can be selected based on the burner 34 and its dimensions. The overall height H can be selected based on the melting chamber 10 and its dimensions. In some aspects, the overall height H can be between 0 to the first height 26 of the non-fluid-cooled portion 24 of the chamber wall 12, including all ranges, subranges, and values therebetween.

The first cap diameter D1 and the second height 92 can be adjustable such that the first cap diameter D1 varies from being the same as the second cap diameter D2 to L and the second height 92 varies from 0 to the overall height H. In particular, the overall height H of the cap 52 can be substantially or approximately equal to or less than the first height 26 of the non-fluid-cooled portion 24 of the chamber wall 12.

As one advantage of using either the cap 52, as described herein, these components can be shaped to easily fit within the passage 18 no matter what the shape of the passage 18 or the burner 34. Thus, there would be no additional need to enlarge the passage 18 in order to accommodate either of the cap. Enlarging the passage 18 can cause unintended leaks to occur. These geometries make it easy to fit any type of passage 18 or burner 34 in the melting chamber 10.

As an additional or alternative advantage of the present disclosure, the cap 52 can have various geometries and designs that are independent from the burner 34. Because the two parts are not necessarily directly connected to each other, it is possible to use geometries and designs for the cap 52 and the burner 34 that are separate from one another, in addition to shapes of the cap 52, the burner 34 can have different orientations. FIGS. 3-7 depict different possible orientations of the burner 34. As mentioned above, the burner 34 in FIG. 1 has the coolant passages 64. It is also possible to use a burner without the coolant passages 64, as in FIGS. 3-7. Providing a burner 34 without the coolant passages 64 simplifies the burner design, operation, and allows the use of burners without the coolant passages. If there are no coolant passages 64 in the burner 34, it is possible that the second height 30 of the fluid-cooled portion 28 will be greater in the volume around the burner 34 than the second height 30 of the fluid-cooled portion 28 in other areas of the chamber wall 12 in order to sufficiently cool the chamber wall 12 in the area of the burner 34 without using cooling fluid provided in the burner 34.

In FIGS. 3-7, like components will be depicted with like numerals as in FIG. 1, increased by 100, 200, etc. The differences in the burner structure will be discussed herein and any similarities may not necessarily be discussed. Accordingly, the descriptions of the various aspects and embodiments are incorporated into one another, and description of subject matter common to the embodiments generally may not be repeated here. In FIG. 3, the cap 152 has an overall height H that can be smaller than, equal to, or larger than the first height of the non-fluid-cooled portion 124. The outer and inner burner diameters 144, 146 of the burner 134 extend past or distal to the boundary 132 of the non-fluid-cooled and fluid-cooled portions 124, 128 of the chamber wall 112, along the passage 118, so that the outer and inner burner diameters 144, 146 extend along both of the non-fluid-cooled and fluid-cooled portions 124, 128.

In this aspect, the distal end 150 of the central conduit 148 is proximal the boundary 132 of the non-fluid-cooled and fluid-cooled portions 124, 128 along the passage 118 so that the central conduit 148 extends along only the fluid-cooled portion 128 and not the non-fluid-cooled portion 124. In other words, the outer and inner burner diameters 144, 146 extend distal to the distal end 150 of the central conduit 148 along the passage 118. It is also possible to have the small gap or void (FIG. 1 (63)) between the distal end of the outer and inner burner diameters 144, 146, or the distal end of the burner 134, and the cap 152.

In this aspect, the outer and inner burner diameters 144, 146 extend above the fluid-cooled portion 128 so that the cap 152 has a cutout volume and is shaped to accommodate the outer and inner burner diameters 144, 146. It is also possible for the components to be oriented such that tire outer and inner burner diameters 144, 146 extend along both of the non-fluid-cooled and fluid-cooled portions 124, 128 and not into the cutout volume of the cap 152. While the connection 178 and the oxidant and fuel inlets 174, 176 are similar to those in FIG. 1, the different positions of the distal end 150 of the central conduit 148 can lead to different mixing of the oxidant and fuel and different temperature profiles and oscillations.

Contrastingly in FIG. 4, while the distal end 250 of the central conduit 248 is substantially the same as in FIG. 3, being proximal the boundary 232, the outer and inner burner diameters 244, 246 of the hunter 234 extend along the passage 218, but do not extend along either of the non-fluid-cooled and fluid-cooled portions 224, 228. The outer and inner burner diameters 244, 246 are also proximal the boundary 232. The connection 278 and the oxidant and fuel inlets 274, 276 are similar to those in FIG. 1; however, the different orientations of the burner components provide more design flexibility and can create a different mixing of the oxidant and fuel, leading to different temperature profiles and oscillations. Additionally, changing the distal end 50 of the central conduit 48 can change the flame profile and combustion efficiency.

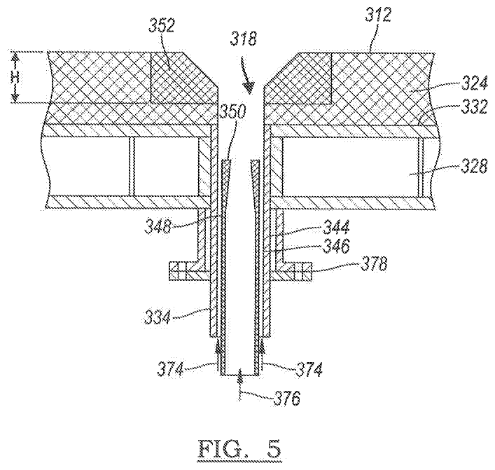

FIG. 5 depicts that the cap 352 has the overall height H that is less than the first height (FIG. 1 (26)) of the non-fluid-cooled portion 324 of the chamber wall 312, similar to the cap height in FIG. 1. This aspect allows the cap 352 to be of a smaller volume, and also potentially use less of the First material for the cap 352. In FIG. 5, while the distal end 350 of the central conduit 348 of the burner 334 is substantially the same as in FIGS. 3-4, being proximal the boundary 332, the outer and inner burner diameters 344, 346 extend along only the fluid-cooled portions 324. They extend up to at least proximal to the boundary 332 of the non-fluid-cooled and fluid-cooled portions 324, 328 along the passage 318. If there is the void (FIG. 1 (63)), the outer and inner burner diameters 344, 346 may only extend to proximal the boundary 332. However, if there is no void (FIG. 1 (63)), the outer and inner burner diameters 344, 346 may extend up to the boundary 332. The connection 378 and the oxidant and fuel inlets 374, 376 are similar to those in FIG. 1; however, different mixing and temperature profiles are possible.

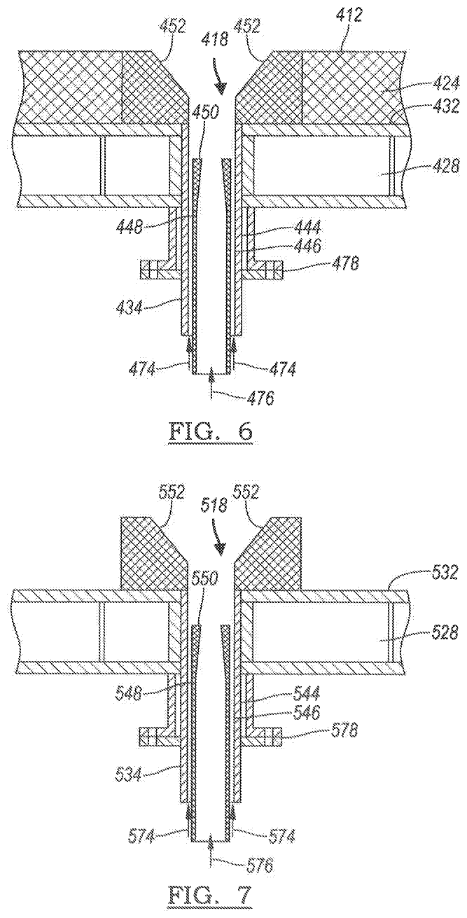

In FIG. 6, the distal end 450 of the central conduit 448 of the burner 434 is substantially the same as in FIGS. 3-5, being proximal the boundary 432. The outer and inner burner diameters 444, 446 extend along only the fluid-cooled portions 428. They extend up to or proximate to the boundary 432 of the cap 452 and the fluid-cooled portion 428 along the passage 418. In this example, the fluid-cooled portion 428 can separate from the outer burner diameter 444. The connection 478 and the oxidant and fuel inlets 474, 476 are similar to those in FIGS. 1 and 3-5; however, different mixing and temperature profiles are possible. FIG. 7 illustrates where the cap 552 is not surrounded by a non-fluid-cooled portion of the chamber wall. Instead, the cap 552 is disposed directly on the boundary 532 of the fluid-cooled portion 528, and the molten material from the melting chamber 10 directly contacts the cap 552 and the fluid-cooled portion 528. The cap 552 remains to protect the fluid-cooled portion 528 proximate to the burner 534. The other components in FIG. 7 are similar to those in FIGS. 1 and 3-6.

Even though FIGS. 1 and 3-7 depict different combinations of the relative positions and orientations of the cap 52, 152, 252, 352, 452, 552 the outer and inner burner diameters 44, 144, 244, 344, 444, 544, 46, 146, 246, 346, 446, 545 and the central conduit 48, 148, 248, 348, 448, 548 any combination of these features is possible. For example, while FIG. 5 depicts the cap 352 having the overall height H that is less than the first height of the non-fluid-cooled portion 324 and also that the outer and inner burner diameters 344, 346 extend only up to the boundary 332, it is possible that the cap could have the overall height H equal to die first height of the non-fluid-cooled portion 324 and/or that the outer and inner burner diameters 344, 346 could extend as shown in another figure.

FIGS. 8-10 depict data of the above-described aspects and embodiments. Computational Fluid Dynamics (CFD) have been used to model the temperature profiles in die melting chamber 10. The data provided in FIGS. 8-10 shows that the cap 52, 152, 252, 352 can protect the components of the melting chamber 10, especially the burner 34, 134, 234, 334 and the chamber wall 12, 112, 212, 312, and lead to a longer lifespan and less wear and/or repair than without the cap.

FIG. 8 depicts time in seconds on the x-axis versus temperature in Kelvin on the y-axis of the distal end 38 of the burner 34 without the cap (line 100) and with the cap (line 102). The temperature data depicted in FIG. 8 was collected from die distal end 38 of the burner, either with the cap or without. The temperature of the molten material, or molten glass, is 1673 K. Line 100, without the cap, shows that the temperature at the distal end 38 of the burner undergoes approximately 3-4 temperature peaks or spikes per second. For the majority of peaks, the temperature drops below the temperature of the molten material and, subsequently, returns back to the temperature of the molten material before experiencing another peak. The net variation in the temperature of the majority of peaks is up to 640 K.

For approximately 30% of the peaks, the temperature drops below the temperature of the molten material and, subsequently, it increases to a higher value than the temperature of the molten material, and, finally, it returns back to the temperature of the molten material before experiencing another peak. The net variation in the temperature of the approximately 30% of peaks is up to 1070 K.

In line 102 with the cap, the distal end 38 of the burner is now covered by the cap, being in the middle, bottom of the cap. The temperature depicted is always below the temperature of the molten material, 1673 K, and approximately 150 K below the temperature of the molten material. Further, the temperature of line 102 decreases steadily with time, over the approximately six seconds of data collected. While not wishing to be bound by any particular theory, the present inventors believe that the decrease in temperature below the temperature of the molten material depends on the first material 80 selected for the cap, and its thermal conductivity, and on any cooling from the burner, for example, with the coolant passages 64.

Additionally, there are no temperature peaks or oscillations in line 102. Therefore, the distal end 38 of the burner is always at a lower temperature, or cooler than, the temperature of the molten material and does not experience the temperature oscillations.

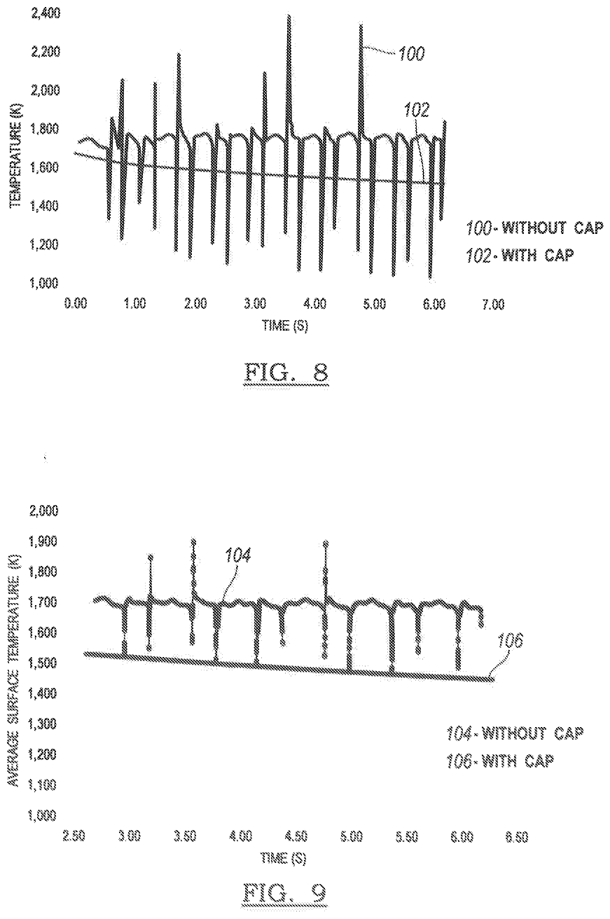

To better understand the temperature profile above the burner, FIG. 9 depicts the average temperature of the horizontal surface that includes the distal end 38 of the burner. FIG. 9 depicts time in seconds on the x-axis versus temperature in Kelvin on the y axis of the horizontal surface that includes the distal end 38 of the burner without the cap (line 104) and with the cap (line 106). In other words, the temperature profile depicted in FIG. 9 reflects the entire surface underneath the cap, as opposed to only at the distal end 38 of the burner, as in FIG. 8. Line 104, compared to line 100, shows similar temperature oscillations, but the net variation in the temperature of each peak is smaller when measuring the entire horizontal surface. Line 106, compared to line 102, shows the same decreased temperature compared to the temperature of the molten material and no temperature peaks or oscillations.

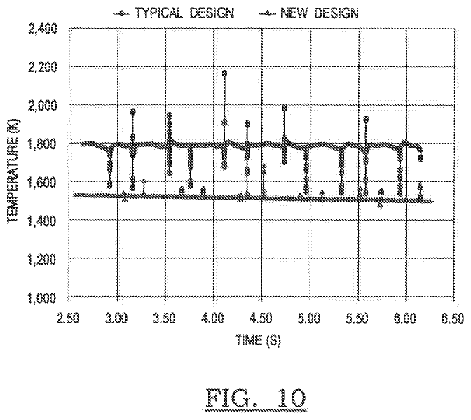

Because the inner wall edge 22 of the chamber wall can also experience significant wear and potential cracks, FIG. 10 depicts the temperature at the inner wall edge 22 and without the cap, in the line with the circles, and the temperature at the inner cap edge 58 and with the cap, in the line with the triangles. FIG. 10 depicts time in seconds on the x-axis versus temperature in Kelvin on the y-axis. Because the cap acts as an extension of the chamber wall, the temperatures at the inner wall edge 22 and the inner cap edge 58 are comparable locations of the melting chamber 10.

As can be seen in FIG. 10, the temperature at the inner wall edge 22 is about 260 K higher than the temperature at the inner cap edge 58. The temperature at the inner wall edge 22 is above the temperature of the molten material (1673 K), while die temperature at the inner cap edge 58 is below that of the molten material. Without wishing to be bound by any particular theory, the present inventors believe that the lower temperature with the cap is due at least in part to the oxidant and/or combustion gases with relatively lower temperatures passing by the inner cap edge 58.

Both lines depict some temperature oscillations as the combustion gases pass by the respective edges 22, 58; however, the maximum temperatures, as well as the magnitude of the net variation in the temperature, when using the cap are lower compared to without the cap. Without the cap, the frequency of the peaks or oscillations at the inner wall edge 22 is approximately the same as the frequency of the peaks or oscillations at the distal end 38 of the burner, believed to be caused by the rapid change in flow pattern of combustion gases as the fuel and oxidant enter the burner, combust, and the gas bubbles move away from the burner. With the cap, the temperature oscillations are smaller; thus, protecting the chamber wall.

There thus has been disclosed a cap for melting chamber, that fully satisfies one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. For example, the subject matter of each of the embodiments is hereby incorporated by reference into each of the other embodiments, for expedience. The disclosure is intended to embrace all such modifications and variations as fall within the spirit and broad scope of the appended claims.

1. A melting chamber comprising:
a chamber wall having a longitudinal axis and forming a passage having a passage axis transverse to the longitudinal axis, the chamber wall including an inner wall surface with an inner wall edge extending about the passage;
a burner positioned in the passage and having a tubular body with a burner end spaced away from the inner wall edge so that a space exists between the burner end and the inner wall edge, the tubular body also having an outer burner diameter, an inner burner diameter, and a central conduit within the inner burner diameter; and
a cap at least partially positioned in the space between the burner end and the inner wall edge, the outer cap surface also having an inner cap edge having a cap diameter, the inner cap edge extending about the central conduit so that it forms a bore coaxially aligned with the passage.

2. The melting chamber of claim 1, wherein the chamber wall is a floor of the melting chamber.

3. The melting chamber of claim 1, wherein no coolant passages for a cooling fluid are disposed within the tubular body of the burner.

4. The melting chamber of claim 1, wherein the tubular body of the burner is spaced away from the cap along the passage axis.

5. The melting chamber of claim 1, wherein the cap is only disposed between the burner end and the inner wall edge along the passage axis.

6. The melting chamber of claim 1, wherein the cap has a cap exterior and a cap interior with a first cap diameter D1 and a second cap diameter D2, the first cap diameter D1 is disposed at the inner cap edge and the second cap diameter D2 is disposed along the passage axis so that the second cap diameter D2 is less than or equal to the first cap diameter D1.

7. The melting chamber of claim 6, wherein the first cap diameter D1 tapers along the passage axis so that D2 is less than D1.

8. The melting chamber of claim 1, wherein the inner cap edge is substantially aligned with the inner burner diameter.

9. The melting chamber of claim 1, wherein the chamber wall comprises a non-fluid-cooled portion having a first height and a fluid-cooled portion having a second height, the non-fluid-cooled and fluid-cooled portions being disposed in two layers and contacting each other at a boundary, and wherein the cap has a cap height that is substantially equal to or less than the first height of the non-fluid-cooled portion.

10. The melting chamber of claim 9, wherein the outer and inner burner diameters and the central conduit of the tubular body extend along the fluid-cooled portion, towards the inner wall surface of the chamber wall, and at least proximal to the boundary of the non-fluid-cooled and fluid-cooled portions.

11. The melting chamber of claim 10, wherein the outer and inner burner diameters of the tubular body extend past the boundary of the non-fluid-cooled and fluid cooled portions so that the outer and inner burner diameters extend along both of the non-fluid-cooled and fluid-cooled portions.

12. The melting chamber of claim 10, wherein the outer and inner burner diameters of the tubular body extend along the passage axis but do not extend along either of the non-fluid-cooled and fluid-cooled portions, and wherein the central conduit has a distal end that is distal to the outer and inner burner diameters.

13. The melting chamber of claim 1, wherein the cap is separable from at least one of the burner and the chamber wall.

14. The melting chamber of claim 1, wherein the tubular body of the burner comprises coolant passages for a cooling fluid.

15. A melting chamber comprising:
a chamber wall having a longitudinal axis and forming a passage having a passage axis transverse to the longitudinal axis, the chamber wall including an inner wall surface with an inner wall edge extending about the passage, and wherein the chamber wall comprises a non-fluid-cooled portion and a fluid-cooled portion so that the non-fluid-cooled and fluid-cooled portions are disposed in two layers and contact each other at a boundary; and
a burner positioned in the passage and having a tubular body with a burner end spaced away from the inner wall edge so that a space exists between the burner end and the inner wall edge, the tubular body having no coolant passage for a cooling fluid and having an outer burner diameter, an inner burner diameter, and a central conduit within the inner burner diameter, and wherein the outer and inner burner diameters of the tubular body extend at least to the boundary of the non-fluid-cooled and fluid-cooled portions.

16. The melting chamber of claim 15, further comprising a cap positioned in the space between the burner end and the inner wall edge wherein the cap has a body with an outer cap surface aligned with the inner wall surface, die outer cap surface also having an inner cap edge having a cap diameter, the inner cap edge extending about the central conduit so that it forms a bore coaxially aligned with the passage.

17. A melting chamber comprising:
a chamber wall having a longitudinal axis and forming a passage having a passage axis transverse to the longitudinal axis, the chamber wall including an inner wall surface with an inner wall edge extending about the passage, and wherein the chamber wall comprises a non-fluid-cooled portion and a fluid-cooled portion so that the non-fluid-cooled and fluid-cooled portions are disposed in two layers and contact each other at a boundary; and
a burner positioned in the passage and having a tubular body with a burner end spaced away from the inner wall edge so that a space exists between the burner end and the inner wall edge, the tubular body having no coolant passage for a cooling fluid and having an outer burner diameter, an inner burner diameter, and a central conduit within the inner burner diameter, and wherein the outer and inner burner diameters of the tubular body extend along the passage axis but do not extend along either of the non-fluid-cooled and fluid-cooled portions, and wherein the central conduit has a distal end that is distal to the outer and inner burner diameters.

18. The melting chamber of claim 17, further comprising a cap positioned in the space between the burner end and the inner wall edge wherein the cap has a body with an outer cap surface aligned with the inner wall surface, the outer cap surface also having an inner cap edge having a cap diameter, the inner cap edge extending about the central conduit so that it forms a bore coaxially aligned with the passage.
